(19) United States
(12) Patent Application Publication
(10) Pub. No.: US 2023/0326731 A1
(43) Pub. Date: Oct. 12, 2023

(54) CALIBRATION AND TUNING METHOD FOR MASS SPECTROMETER

(71) Applicant: NPL MANAGEMENT LIMITED, Teddington Middlesex (GB)

(72) Inventors: Efstathios ELIA, Teddington Middlesex (GB); Josephine BUNCH, Teddington Middlesex (GB)

(21) Appl. No.: 18/025,123

(22) PCT Filed: Sep. 8, 2021
(86) PCT No.: PCT/GB2021/052317

§ 371 Date: Mar. 7, 2023

(30) Foreign Application Priority Data
Sep. 8, 2020 (GB) 2014089.3

(51) Int. Cl. H01J 49/00; H01J 49/16

(52) U.S. Cl. CPC H01J 49/0031; H01J 49/0009; H01J 49/164; H01J 49/165

(57) ABSTRACT

A method of calibrating and/or tuning a mass spectrometer includes the steps of: (i) providing a sample; (ii) producing ions from a surface of the sample by means of an ion-producing method, and (iii) using said ions to calibrate a mass spectrometer, tune a mass spectrometer or a combination thereof, wherein the ion producing method is desorption electrospray ionisation (DESI). A vacuum-deposited PLA glass slide can also be used as a calibration/tuning sample for any ion-producing method, e.g. DESI, MALDI or SIMS.

The present invention relates to a method of calibrating and/or tuning a mass spectrometer, and in particular a calibration and/or tuning method for use during surface analysis by mass spectrometry and/or mass spectrometry imaging and more specifically desorption electrospray ionisation (DESI). It also relates to a method of calibrating and/or tuning a mass spectrometer using any ion-producing method which uses ions produced from a polylactic acid sample.

The introduction of ambient ionisation mass spectrometry has undoubtedly revolutionised the application and adoption of mass spectrometry. This is a form of ionisation in which ions are formed in an ion source outside the mass spectrometer without sample preparation or separation. For example, ions can be formed by extraction into charged electrospray droplets, thermally desorbed and ionised by chemical ionisation, or laser desorbed or ablated and post-ionised before they enter the mass spectrometer.

Even though minimal sample preparation is required for most of such ambient ionisation methods, achieving the highest sample throughput can potentially be hindered by factors not associated with sample preparation.

Factors that particularly influence throughput for Desorption Electrospray Ionisation Mass Spectrometry Imaging (DESI-MSI) is routine calibration of the mass analyser, as well as optimal tuning of ion transmission. Currently, external mass calibration and tuning of instruments that are routinely used with a DESI ion source is carried out by replacing the DESI source with an electrospray ionisation (ESI) source. Once the ESI source is fitted, a more conventional mass calibration and tuning routine is performed. For calibration it is common practice to use suitable calibration compounds such as sodium formate, sodium iodide/caesium iodide or mass analyser specific compounds. A similar approach is also followed for ion transmission tuning. The use of ESI for calibrating mass spectrometers has been common since the 1990s.

However, removal of the DESI source from the instrument, although a relatively simple task, is likely to cause a deviation from the optimised DESI setup that was achieved prior to the source removal. Having to re-optimise the geometry of the DESI spray head, can lead to a significant delay in sample analysis, even for experienced DESI users.

In addition. in order to ensure that any mass spectrometer is performing according to, or exceeding manufacturer performance standards, it is necessary to not only calibrate the mass analyser but also to tune transmission of generated ions. Tuning is achieved through the fine adjustment of voltages across a series of electrodes allowing for efficient transmission of the ions of interest from the ion source to the mass analyser. Routine tuning of a mass spectrometer will ensure optimal sensitivity and repeatability of any measurement, whilst also providing an insight into deviations from expected optimised parameters.

A prerequisite for tuning a mass spectrometer is the production of a constant flow of ions, usually through the use of ESI, across a specific m/z range for the instrument being tuned that covers the m/z range of interest, for a suitable time period to allow for manual or automatic adjustment of several instrument parameters.

The ions used for tuning should originate from the ionisation of single compounds or fragmentation products of these compounds. For mass spectrometers fitted with other ion sources such as DESI, there exists no other alternative but to replace the DESI source with ESI, perform tuning and re-fit the DESI source. The ability to tune a mass spectrometer directly using a DESI source would significantly increase sample throughput.

US 2005/056776 A1 (Willoughby Ross et al.) discloses a method of configuring atmospheric pressure, intermediate pressure and vacuum laser desorption ionization methods and ion sources in order to increase the efficiency of transmitting ions to a mass to charge analyser or ion mobility analyzer.

EP 2778684 A1 (Zentech) discloses a method for detection and/or quantification of at least one molecule presents in blood by a MALDI-MS analysis of a dried fluid spot without the presence of any digestion step or liquid extraction step, which permits further analysis of the physical distribution of at least one molecule within a dried fluid spot. The present invention seeks to provide a calibration and/or tuning method which addresses at least some of the disadvantages outlined above.

In a first aspect of the present invention, there is provided a method of calibrating and/or tuning a mass spectrometer including the steps of:
(i) providing a sample;
(ii) producing ions from a surface of the sample by means of an ion-producing method, and
(iii) using said ions to calibrate a mass spectrometer, tune a mass spectrometer or a combination thereof,
   wherein the ion producing method is desorption electrospray ionisation (DESI).

The advantage of the inventive method is that it provides an external calibration and/or tuning method that does not involve removal of the DESI source that can be used prior to any sample analysis, limiting any instrument down time and increasing throughput.

The method may include steps preceding step (i) of:
(a) producing ions by means of an ion-producing method which is DESI, and
(b) using said mass spectrometer to analyse said ions.

The method may include the additional step after step (iii) of
(iv) using said calibrated and/or tuned mass spectrometer to analyse ions produced by an ion-producing method which is DESI.

In a preferred embodiment, the calibration sample is a homogeneous layer formed of a single type of molecule or a mixture of types of molecules. The calibration sample may be selected so as to form a series/cluster of gaseous ions within a specific mass range of interest.

Preferably the calibration sample is a polyester such as polylactic acid (PLA). However, it may also be 2,5-dihydroxybenzoic acid (2,5-DHB, monoisotopic mass: 154.02661), α-cyano-4-hydroxycinnamic acid (CHCA, monoisotopic mass: 189.04259), caffeine (monoisotopic mass: 194.08038), rhodamine B (monoisotopic mass: 443.23347), angiotensin I (Angio I, monoisotopic mass: 1295.67749), or angiotensin II (Angio II, monoisotopic mass: 1045.53455) or a mixture thereof.

The calibration sample may be prepared by sublimating granules of PLA with a molecular weight of less than 2000 Da onto a glass slide.

In a second aspect of the invention, there is provided a method of calibrating and/or tuning a mass spectrometer including the steps of:
(i) providing a sample;
(ii) producing ions from a surface of the sample by means of an ion-producing method, and
(iii) using said ions to calibrate a mass spectrometer, tune a mass spectrometer or a combination thereof,
wherein the sample comprises polylactic acid (PLA) which has been vacuum-deposited onto glass.

It has surprisingly been discovered that the use of PLA which has been vacuum-deposited onto glass provides an effective sample for multiple types of ion-producing method.

The method may include steps preceding step (i) of:
(a) producing ions by means of an ion-producing method, and
(b) using said mass spectrometer to analyse said ions.

The method may include the additional step after step (iii) of
(iv) using said calibrated and/or tuned mass spectrometer to analyse ions produced by an ion-producing method.

The ion producing methods may be the same in every step and may independently include desorption electrospray ionisation (DESI), secondary ion mass spectrometry (SIMS) or matrix assisted laser desorption/ionisation (MALDI).

A number of preferred embodiments of the present invention will now be described with reference to and as illustrated in the accompanying drawings, in which:

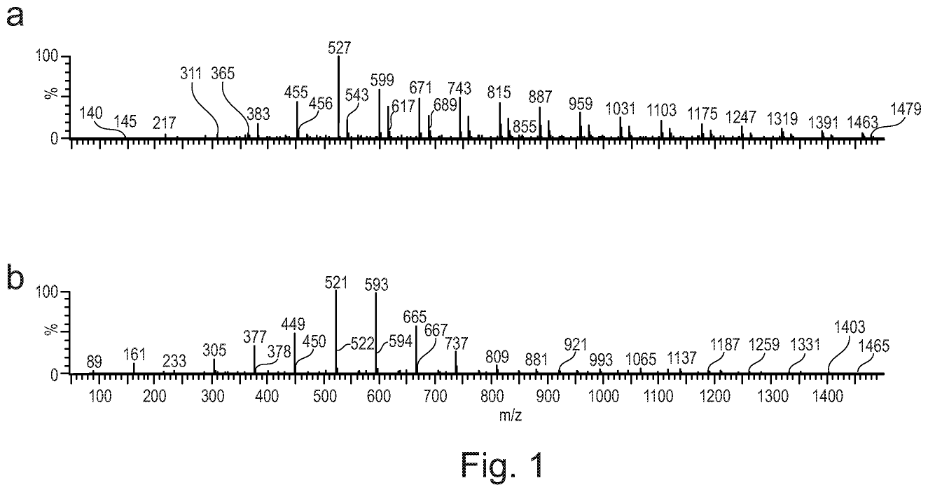

FIG. 1 shows single scan mass spectra of (a) +ve ion DESI and (b) −ve ion DESI acquired using a quadrupole time of flight mass analyser in accordance with the invention;

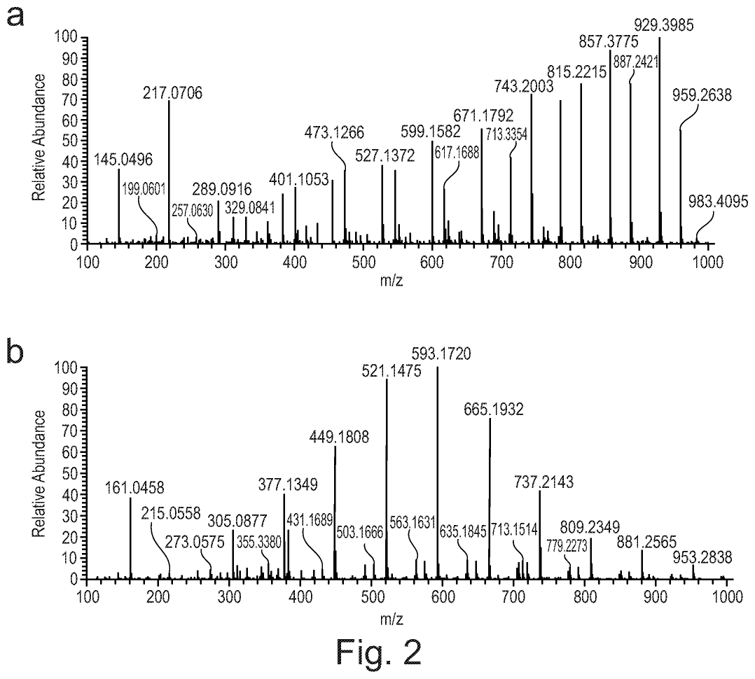

FIG. 2 shows mean mass spectra of (a)+ve ion DESI and (b) −ve ion DESI acquired using an Orbitrap mass analyser;

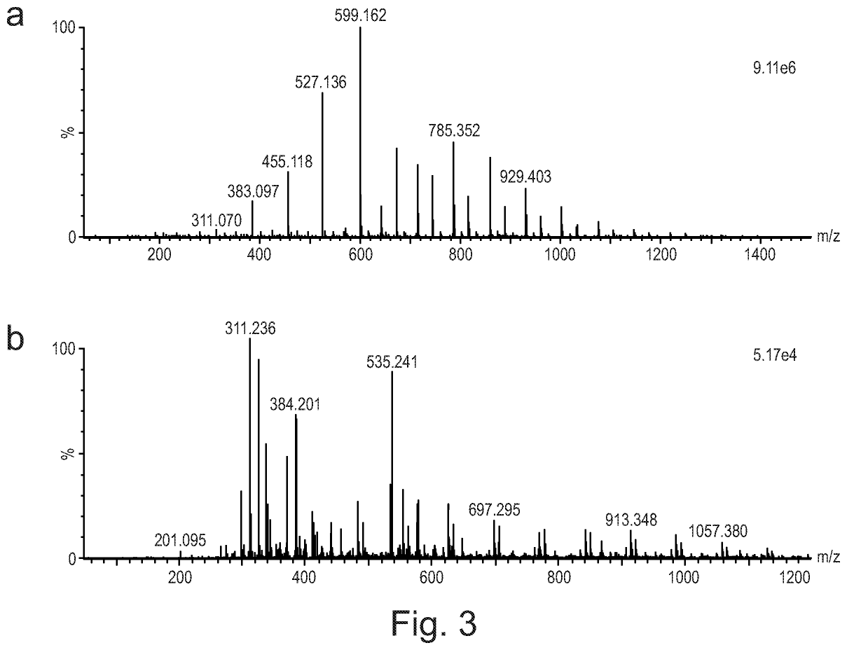

FIG. 3 shows mean mass spectra of (a)+ve ion MALDI and (b) −ve ion MALDI acquired using a quadrupole time of flight mass analyser;

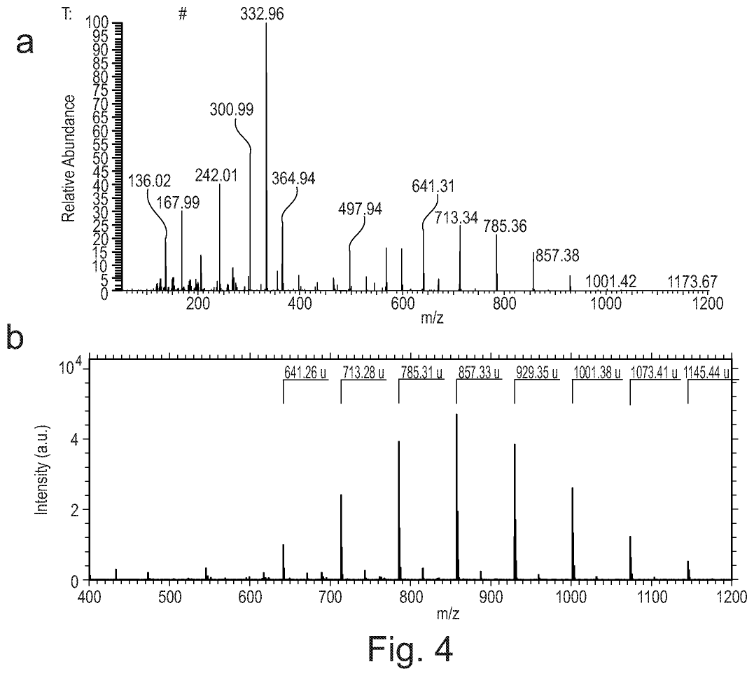

FIG. 4 shows mean mass spectra of (a)+ve ion SIMS acquired using the time of flight mass analyser and (b)+ve ion SIMS acquired using the Orbitrap mass analyser;

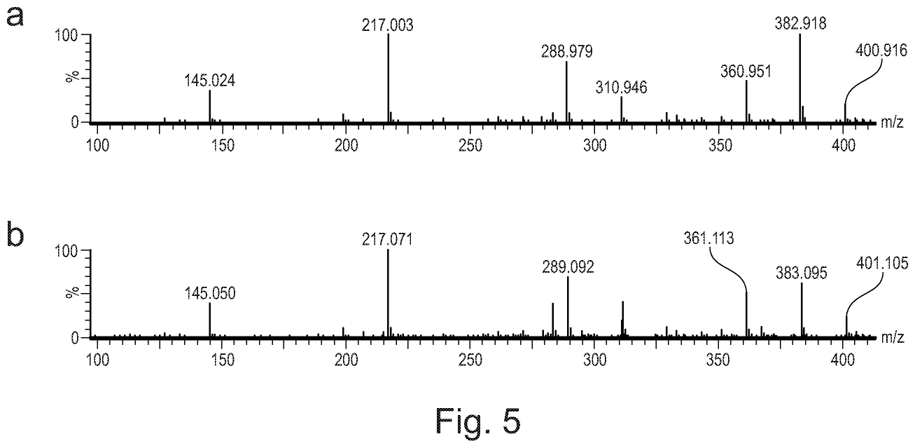

FIG. 5 shows centroid mean mass spectra in the range of m/z 100-450 for +ve ion DESI of said PLA coated slide (a) prior to and (b) immediately after calibration of the mass analyser in a quadrupole time of flight mass analyser;

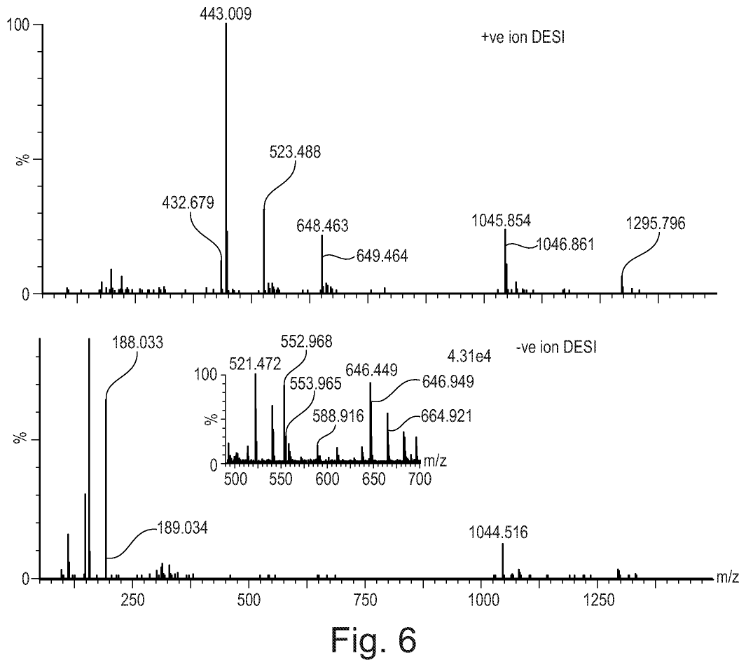

FIG. 6 shows mean mass spectra of (a)+ve ion DESI and (b) −ve ion DESI acquired from a slide coated in a selection of chemicals other than PLA, using a quadrupole time of flight mass analyser;

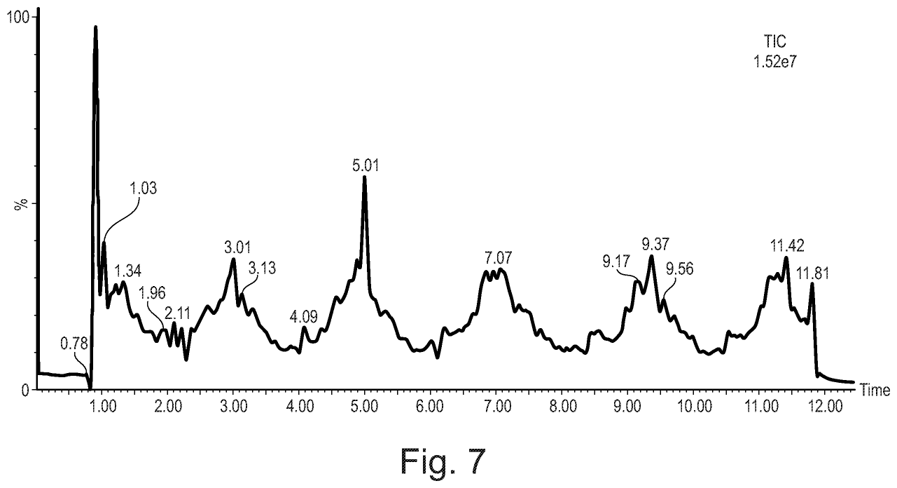

FIG. 7 shows a graph of relative total ion current detected over time by continuously sampling a PLA coated slide using DESI in +ve ion mode; and

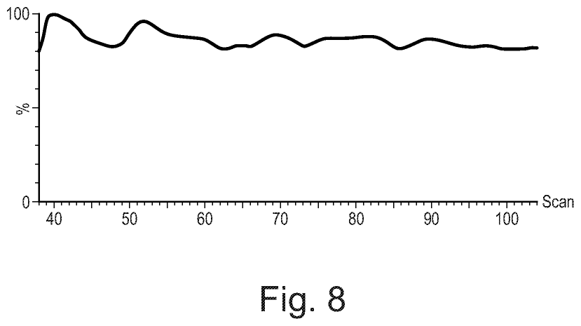

FIG. 8 shows a further graph of relative total ion current over time by continuously sampling a PLA coated slide using DESI in +ve ion mode.

### EXPERIMENTAL

Glass slides (SuperFrost Plus, Thermo Scientific, Waltham, MA) were cleaned by sonicating in methanol for 5 minutes. After drying under nitrogen, glass slides were stuck under the cold finger of a 150 mL sublimation apparatus (Chemglass, Vineland, NJ) using double sided thermal tape. Granules of polylactic acid (PLA, 2 kDa, ˜100 mg) were placed on the bottom of the condenser flask. The cold finger was filled with dry ice and water and the apparatus was heated using a hot plate. A vacuum of 2.2*10⁻² bar was achieved using an Edwards E2M1.5 rough pump; pressure was monitored using an Edwards TIC 3 Head Instrument Controller. The hot plate was heated up to 390° C. and PLA was allowed to sublime over 10 minutes. Following this, the chamber was flooded with N₂ to avoid any condensation on the slide and allowed to reach room temperature and pressure.

In addition to the described method of vacuum coating PLA, several other methods of coating were trialed. Initially, PLA powder was dissolved in chloroform at a concentration of 10 mg/mL. This solution was then deposited on clean glass slides using a spin-coater (4000 rpm, for 60 s), using a dip coater and droplet deposition using a pipette. The coated slides were allowed to dry at ambient conditions prior to any analysis. In all instances other than dip coating, the coated slide was placed, uncoated side down, on a standard laboratory hot plate held at 300° C. In addition, sheets of PLA were purchased and tested either as provided or by placing a 20×20 mm cut-out of the sheet on a glass slide and placing slide on a hot plate held at 300° C.

All slides prepared by the methods described above were placed under the DESI sprayer to investigate the ability to produce ions from these surfaces. None of the described preparations was suitable to produce a surface from which PLA related ions could be detected by the mass spectrometer.

### Example A—Use of Polylactic Acid Sample to Calibrate Various Mass Spectrometers Using a DESI Ionisation Source

PLA coated slides were shipped to collaborators at two different sites to be assessed as a DESI compatible mass analyser calibration standard. Given that each laboratory had a different DESI sprayer setup, it was requested that each uses their optimised DESI conditions for the experiments, with the limitation of keeping all sources of external heat turned off.

DESI data were acquired using:
Example A1—2 Waters Xevo G2-XS QToFs mass spectrometers
Example A2—1 Waters Synapt G2-Si QToF mass spectrometer
Example A3—1 Thermo Q-Exactive mass spectrometer.

All instruments were fitted with a Prosolia 2D DESI stage (Prosolia, Indianapolis, IN); the Waters instruments were used with a modified DESI sprayer supplied by Waters, while the Q-Exactive was used with a home-built FS sprayer. The DESI solvent, in all experiments, was 95:5 (v:v) methanol:water, infused at a flow rate of 1.5 μL/min. Mass spectrometers were operated in both positive and negative ion modes with 5 and 4 kV applied to the sprayer assembly respectively.

As can be seen in FIG. 1, peaks spanning the m/z range of interest are detected. These ions correspond to the various lengths of PLA polymer and are in agreement with previously published mass spectra generated using ESI, MALDI and Atmospheric Solids Analysis Probe (ASAP) ionisation. Based on our observations, the PLA granules used might contain a mixture of cyclic PLA (CPLA) and linear PLA (LPLA). The spectra shown in FIG. 1 can be explained by the fragmentation patter for the two molecules suggested by Osaka et al (Osaka, I., Watanabe, M., Takama, M., Murakami, M. and Arakawa, R. (2006), Characterization of linear and cyclic polylactic acids and their solvolysis products by electrospray ionization mass spectrometry. J. Mass Spectrom., 41: 1369-1377).

For positive (+ve) ion DESI, both LPLA and CPLA were detected either as protonated or sodiated molecules, whilst for negative (−ve) ion DESI only LPLA was detected as deprotonated molecules. Application of a collision energy, usually between 20-30 keV, resulted in the fragmentation of the higher molecular weight PLA ions, allowing for the expansion of the calibration range below m/z 100. It has to be noted that use of PLA as a calibration standard for DESI is reliant on no addition of heat on the inlet capillary for Waters instruments, whilst when analysed using the Thermo Q-Exactive application of a capillary temperature of 320° C. was necessary. The exact masses of the ions used to calibrate the mass analyser are shown in Table 1.

TABLE 1
Exact masses of the PLA ions used to perform an external
calibration of the mass analyser in the range of 50-
1500 m/z for +ve and −ve ion DESI. For all ions,
M is the PLA monomer with a mass of 72.02113 Da.

| Adduct | m/z | Adduct | m/z |
|---|---|---|---|
| [2M + H2O − H]⁻ | 89.024419 | [2M − H2O + H]⁺ | 127.0390 |
| [3M + H2O − H]⁻ | 161.04555 | [2M + H]⁺ | 145.0495 |
| [4M + H2O − H]⁻ | 233.06668 | [3M + H]⁺ | 217.0706 |
| [5M + H2O − H]⁻ | 305.087809 | [4M + H]⁺ | 289.0918 |
| [6M + H2O − H]⁻ | 377.108939 | [4M + Na]⁺ | 311.0743 |
| [7M + H2O − H]⁻ | 449.130068 | [5M + Na]⁺ | 383.0954 |
| [8M + H2O − H]⁻ | 521.151198 | [6M + Na]⁺ | 455.1165 |
| [9M + H2O − H]⁻ | 593.172328 | [7M + Na]⁺ | 527.1377 |
| [10M + H2O − H]⁻ | 665.193459 | [8M + Na]⁺ | 599.15881 |
| [11M + H2O − H]⁻ | 737.214589 | [9M + Na]⁺ | 671.17994 |
| [12M + H2O − H]⁻ | 809.235719 | [10M + Na]⁺ | 743.20107 |
| [13M + H2O − H]⁻ | 881.256849 | [11M + Na]⁺ | 815.2222 |
| [14M + H2O − H]⁻ | 953.277979 | [12M + Na]⁺ | 887.2433 |
| [15M + H2O − H]⁻ | 1025.29911 | [13M + Na]⁺ | 959.26446 |
| [16M + H2O − H]⁻ | 1097.32024 | [14M + Na]⁺ | 1031.2856 |
| [17M + H2O − H]⁻ | 1169.34137 | [15M + Na]⁺ | 1103.3067 |
| [18M + H2O − H]⁻ | 1241.36249 | [16M + Na]⁺ | 1175.3278 |
| [19M + H2O − H]⁻ | 1313.38363 | [17M + Na]⁺ | 1247.4389 |
| [20M + H2O − H]⁻ | 1385.40476 | [18M + Na]⁺ | 1319.37011 |
| [21M + H2O − H]⁻ | 1457.42589 | [19M + Na]⁺ | 1391.39124 |
| | | [20M + Na]⁺ | 1463.41237 |

The use of PLA coated slides has not shown any evidence of polymer carryover, blockage of DESI emitter tips, or inlet capillaries. Once the sample stage has moved away from the solvent spray, there was no apparent signal from the polymer.

### Example B—Use of Polylactic Acid Sample to Calibrate a Mass Spectrometer Using a MALDI Ionisation Process

MALDI-MS was performed using a Waters Synapt G2-Si mass spectrometer fitted with a Waters MALDI source equipped with a Nd:YAG laser at a wavelength of 355 nm, with repetition rate of 2.5 kHz producing 25 nJ pulses. Mass spectra were acquired in both positive and negative ion modes in the mass range of m/z 50-1200, with the instrument operated in ‘Resolution’ mode. Prior to any MALDI analysis, the PLA coated slides were further coated with a suitable MALDI matrix to enhance desorption and ionisation of the polymer; α-cyano-4-hydroxycinnamic acid (CHCA) and 9-aminoacridine (9-AA) (SigmaAldrich, UK) were used for positive and negative ion MALDI analysis respectively. The matrices were deposited onto PLA coated slides using a TM sprayer (HTX Technologies, USA) with the following settings: 13 passes, 0.07 mL min⁻¹ flow rate, 3 mm track spacing, 65° C., 15 psi nitrogen pressure. The results of Example B are shown in FIG. 3.

### Example C—Use of Polylactic Acid Sample to Calibrate a Mass Spectrometer Using a SIMS Process

SIMS data were acquired using a 3D OrbiSIMS (ION-TOF GmbH, Munster, Germany) equipped with a time-of-flight mass (ToF) mass analyzer and a Q Exactive HF (Thermo Fisher, Bremen, Germany) with an Orbitrap mass analyzer. Individual mass spectra were acquired; a ToF mass spectrum was acquired using 30 keV Bi3⁺ (0.1 pA, at 200 μs cycle time) as an analysis beam with a field of view of 20 μm×20 μm (128×128 pixel). The Orbitrap mass spectrum was acquired using a 5 keV Ar1882⁺ ion beam at a mass resolving power of 240 000, an injection time of 500 ms and a mass range of m/z 100-1500. The field of view was 200 μm×200 μm (70×70 pixel). For both acquisitions, an electron floodgun was used to compensate charging effect over the surface of the sample.

The data acquired by the 3D OrbiSIMS instrument using either the ToF mass analyser or the Orbitrap are consistent with the data acquired using either DESI or MALDI. The higher energy deposited onto the sample during standard SIMS ToF analysis is seen to cause significant fragmentation of the PLA chain.

When said PLA coated slide was used to calibrate the Orbitrap in the 3D OrbiSIMS instrument, calibration was successful up to m/z 1200 which is not easily achieved with current SIMS calibration methods. This is particularly advantageous for the analysis of biological material such as peptides and proteins, where the expectation is the observe these biomolecules at m/z values above 1000. The results of Example C are shown in FIG. 4.

### Example D—Correction of Peak Annotation Following Calibration of Mass Analyser with Coated PLA Slide Using a DESI Setup on a QToF Mass Spectrometer

To evaluate the effectiveness of the proposed PLA coated slide as a suitable mass analyser calibration standard, data were collected using an identical DESI setup and experimental conditions as described in Example A. The mass analyser was returned to its factory default settings and a mass spectrum recorded and shown in FIG. 5(a). A comparison between the peak annotation in the spectrum and the exact mass of the series of ions presented in Table 1 shows the deviation of the annotation from the true m/z values of the ions detected.

Correction of this shift in mass assignment to the exact mass of an ion, i.e. mass calibration, was performed followed by a repeat acquisition of the same PLA sample FIG. 5(b). By calibrating the mass analyser, it is observed that the mass assignments in the calibrated spectrum agrees with the exact masses of the ions in Table 1.

### Example E—Use of Various Compounds to Calibrate Quadrupole Time of Flight Mass Spectrometers Using a DESI and MALDI Ion Source

Although a PLA-coated glass slide was successfully used to calibrate the mass analyser of various mass spectrometers, we also show the applicability of this approach whilst using other compounds, not associated with PLA. Here we have selected and used a small molecule, a common MALDI matrix, a dye and a set of two peptides. The compounds selected were either spray-coated or vacuum deposited onto the same glass slide in various amounts in order to result in a multi-layer structure. The compounds selected were: 2,5-dihydroxybenzoic acid (2,5-DHB, monoisotopic mass: 154.02661), α-Cyano-4-hydroxycinnamic acid (CHCA, monoisotopic mass: 189.04259), caffeine (monoisotopic mass: 194.08038), rhodamine B (monoisotopic mass: 443.23347), angiotensin I (Angio I, monoisotopic mass: 1295.67749), and angiotensin II (Angio II, monoisotopic mass: 1045.53455).

Initially, the two peptides were dissolved in water to form a stock solution of 1 mg/mL. An aliquot of each was taken, diluted in methanol to a working solution of 10 ug/mL, and individually sprayed onto a clean glass slide using a HTX TM-Sprayer. The peptide coated slides were then transferred to an Angstrom NexDep Vapor Deposition Platform (Angstrom Engineering, ON, CA), where 2,5-DHB, CHCA, caffeine and rhodamine were individually deposited with the following settings: 50 nm film thickness deposited at a rate of 5 A/s in a vacuum of 5e-5 torr. Thus, a multi-layer structure was produced with the various layers deposited on the substrate. The substrate was kept at 5° C. and was rotated at 40 rpm.

The completed slides were analysed by MALDI and DESI in both polarities, on a QTof mass spectrometer, immediately following deposition of chemicals; spectra obtained by positive and negative ion DESI are shown in FIG. 6. Data acquired over 10 seconds was sufficient to perform routine mass calibration on both instruments. Desorption of analytes was sufficiently stable for over a minute, which can be easily be used for quadrupole tuning. The stability of the sample was tested after storing the slides in a 4° C. lab fridge for two weeks; the acquired data were identical to the data on day 0.

### Example F—Use of a PLA Slide to Tune a Mass Spectrometer Fitted with a DESI Ionisation Source

A slide was coated with PLA using the experimental method described above. Evidence of the ability of the coated PLA slide to function as a dual calibration/tuning standard is visualised in FIG. 7 which shows the total ion current (TIC) detected over 11 minutes by continuously sampling a PLA coated slide. The frequency of 2.5 minutes observed in the graph represent the acquisition time of each line raster.

A somewhat stable flow of ions over the 11 minute experiment was achieved via the continuous movement of the sample stage under the DESI spray in a line-by-line manner.

The TIC was acquired with optimised parameters so the variable intensity is due to the movement of the stage under the DESI spray. Although the glass slide is entirely coated in PLA, the centre of the slide contains a greater amount of PLA, so as the stage is moving towards the centre of the slide the ion intensity increases and as it moves away it decreases.

Relative total ion current was then detected over 60 scans by continuously sampling the same PLA coated slide. Sampling was performed from a single line raster over the PLA coated slide for 2.2 minutes. The calculated % RSD was below 6%. The results are shown in FIG. 8.

Given the wide range of m/z values covered by PLA, users can select to tune a mass spectrometer for optimised transmission of ions in a specific mass range e.g. 100-200 m/z or 600-1000 m/z hence ensuring optimised instrument sensitivity for ions of interest.

### CONCLUSIONS

With the advancements in ambient MS, higher sample throughput can be achieved, given that the rate limiting step was sample preparation. Having overcome these obstacles, instrumentation down-time has now been realised as the major contributing factor to sub-optimum throughput. For DESI in particular, the need for constant switching back and forth between DESI and ESI for mass calibration has led many research groups to sacrifice routine calibration for faster sample analysis.

A calibration standard has been found that is suitable for use with DESI without the need for ion source change. Low molecular weight PLA has been seen to be a suitable DESI calibration standard, in either positive or negation ion mode. The introduction of the coated PLA slides has rapidly increased the efficiency of the DESI workflow, increasing throughput and minimising down-time due to the elimination of the spray head re-optimisation procedure following calibration using ESI. Use of a PLA slide also enables tuning of the MS due to the range and distribution of ions produced from the slide.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in UK patent application number 2014089.3, from which this application claims priority, and in the abstract accompanying this application are incorporated herein by reference.

1. A method of calibrating and/or tuning a mass spectrometer including the steps of:
(i) providing a sample;
(ii) producing ions from a surface of the sample by means of an ion-producing method; and
(iii) using the ions to calibrate the mass spectrometer, tune the mass spectrometer or a combination thereof,
wherein the ion producing method is desorption electrospray ionisation (DESI).

2. The method as claimed in claim 1, including steps preceding step (i) of:
(a) producing ions by means of an ion-producing method which is DESI, and
(b) using the mass spectrometer to analyse the ions.

3. The method as claimed in claim 1, including an additional step after step (iii) of:
(iv) using the calibrated mass spectrometer to analyse ions produced by an ion-producing method which is DESI.

4. The method as claimed in claim 1, wherein the sample is a homogeneous layer formed of a single type of molecule or a mixture of types of molecules.

5. The method as claimed in claim 1, wherein the sample is a polyester.

6. The method as claimed in claim 1, wherein the sample is a polylactic acid (PLA), 2,5-dihydroxybenzoic acid (2,5-DHB, monoisotopic mass: 154.02661), α-Cyano-4-hydroxycinnamic acid (CHCA, monoisotopic mass: 189.04259), caffeine (monoisotopic mass: 194.08038), rhodamine B (monoisotopic mass: 443.23347), angiotensin I (Angio I, monoisotopic mass: 1295.67749), or angiotensin II (Angio II, monoisotopic mass: 1045.53455).

7. The method as claimed in claim 6, wherein the calibration sample is prepared by vacuum deposition, spray deposition or solvent deposition of molecules of interest.

8. A method of calibrating and/or tuning a mass spectrometer including the steps of:
(i) providing a sample;
(ii) producing ions from a surface of the sample by means of an ion-producing method; and
(iii) using the ions to calibrate the mass spectrometer, tune the mass spectrometer or a combination thereof,
wherein the sample comprises polylactic acid which has been vacuum-deposited onto glass.

9. The method as claimed in claim 8, including steps preceding step (i) of:
(a) producing ions by means of an ion-producing method, and
(b) using the mass spectrometer to analyse the ions.

10. The method as claimed in claim 8, including an additional step after step (iii) of:
(iv) using the calibrated mass spectrometer to analyse ions produced by an ion-producing method.

11. The method as claimed in claim 8, wherein the ion producing methods are the same in every step.

12. The method as claimed in claim 8, wherein the ion-producing methods independently include desorption electrospray ionisation (DESI), secondary ion mass spectrometry (SIMS) or matrix-assisted laser desorption ionisation (MALDI).

13. The method as claimed in claim 1, including the step of determining the distribution of ions that are required to tune the mass spectrometer and providing a sample in step (i) which sample produces ions having the distribution as a result of the ion-producing method of step (ii).

14. The method as claimed in claim 13, wherein the distribution of ions has a mass to charge ratio from 50 to 2000 m/z.

15. The method as claimed in claim 8, including the step of determining the distribution of ions that are required to tune the mass spectrometer and providing a sample in step (i) which sample produces ions having the distribution as a result of the ion-producing method of step (ii).

16. The method as claimed in claim 15, wherein the distribution of ions has a mass to charge ratio from 50 to 2000 m/z.

17. The method as claimed in claim 2, including an additional step after step (iii) of:
(iv) using the calibrated mass spectrometer to analyse ions produced by an ion-producing method which is DESI.
